(19) United States
(12) Patent Application Publication
(10) Pub. No.: US 2008/0144967 A1
(43) Pub. Date: Jun. 19, 2008

(54) Confidential Viewing System Utilizing Spatial Multiplexing

(75) Inventor: David A. Struyk, Deephaven, MN (US)

Correspondence Address: SCHROEDER & SIEGFRIED, P.A., 15600 WAYZATA BOULEVARD, SUITE 200, WAYZATA, MN, 55391, US

(73) Assignee: WATERSTRIKE INCORPORATED, Excelsior, MN (US)

(21) Appl. No.: 10/575,508

(22) PCT Filed: Mar. 30, 2005
(86) PCT No.: PCT/US2005/010807

§ 371 Date: Apr. 13, 2006

Related U.S. Application Data
(60) Provisional application No. 60/557,901, filed on Mar. 30, 2004.

(51) Int. Cl. G06K 9/36

(52) U.S. Cl. 382/276

(57) ABSTRACT

An apparatus and method for providing confidential viewing of a fundamental image on an image display device utilizing spatial multiplexing image modification, whereby fundamental image components of the fundamental image are spatially multiplexed or combined with appropriately determined inverted image components thereof, and aligned with adjacent display regions/pixels of an image display device so as to neutralize the fundamental image and generate a combined image that appears substantially featureless to the naked eye. The display pixels aligned with the fundamental image components are cross-polarized relative to the adjacent pixels aligned with the inverted image components, thereby providing for extraction of the fundamental image by an authorized viewer wearing appropriate eyewear polarized to correlate with the state of polarization of the pixels aligned with the fundamental image components. Enhanced security may be provided by utilizing a variable polarizer to alter the state of polarization of the respective display regions, or by altering the position of fundamental and inverse image components to align with differently polarized display regions. Extraction of the fundamental image may then be accomplished by using active polarized eyewear synchronized to correlate in polarization with the pixels aligned with the fundamental image components.

### CROSS REFERENCE TO RELATED APPLICATIONS

This application is an application for a patent which is also disclosed in Provisional Application Ser. No. 60/557,901, filed on Mar. 30, 2004 by the same inventor, namely David A. Struyk, and entitled “CONFIDENTIAL VIEWING SYSTEM UTILIZING SPATIAL MULTIPLEXING,” the benefit of the filing date of which is hereby claimed.

### BACKGROUND OF THE INVENTION

The present invention is related generally to the art of confidential viewing of display images. More particularly, the present invention is directed to a confidential viewing apparatus and method which utilizes techniques of spatial multiplexing image modification to mask or neutralize a fundamental display image and render it indecipherable to the naked eye, whereby image decoding is available only to the intended viewer.

With the increasing use of video displays for a variety of systems, such as those used in desktop computers, laptop computers, televisions, and personal video entertainment systems, there exists an increasing need and desire to provide confidential viewing of these displays by only those who the displayed content is intended for, thus eliminating the possibility of unauthorized viewing.

Various devices have been introduced over the years to prevent unauthorized viewing of video displays. The simplest devices generally include a form of “anti-glare” privacy screen and/or hoods and shields. These devices are commonly found on desktop computer displays which are intended to restrict viewing to only those who are more or less directly in front of the display. While these are somewhat effective, they cannot prevent viewing by someone peering over ones shoulder, and thus are far from secure.

Other devices have been developed which seek to obscure the view of a fundamental image from an unintended viewer by introducing a “masking image.” One such device is discussed in U.S. Pat. No. 5,614,920, which utilizes a flashing screen of light placed between the video display and the viewer to obscure the fundamental image. Confidential viewing is provided by utilizing time synchronized shutter glasses to block the pulses of light and permit viewing of the fundamental image.

Other similar devices are disclosed in U.S. Pat. Nos. 5,537,476, and 5,619,219. These devices provide secure viewing of a display by introducing a secondary masking light or set of “primary” colors, that are wavelength-shifted from that used to generate the fundamental image. Secure viewing is provided by viewing the composite image through specially formulated narrow-band filtered glasses, which block the wavelength-shifted image, allowing the fundamental image to pass.

Still other devices utilize principles of “time multiplexing” to intermix a masking image with the fundamental image, thereby obscuring its view from the public. Such systems usually alternate display frames of masking and fundamental images, and utilize time synchronized shutter eyewear to decode the fundamental image. These systems, however, suffer inherently from display flicker problems, and often incorporate video “flash” frames which tend to be irritating to the eye. For this reason, such time multiplexing systems are better suited for a cathode ray tube (CRT) display, which can operate at significantly faster refresh rates than a typical liquid crystal display (LCD). Examples of this type of system can be found in U.S. Pat. Nos. 5,629,984; 5,963,371; as well as Japanese Patent No. 05119754 JP.

More sophisticated Confidential viewing systems are disclosed in my two co-pending U.S. patent application Ser. Nos. 10/205,864 and 10/205,866, the contents of which are incorporated herein by reference thereto. Like those previously described, these systems involve applications of image multiplexation over time. However, in this case, principles of color inversion are employed, whereby the fundamental image is encoded by time multiplexing itself with an appropriately determined inverted image in such manner as to produce a neutral, substantially featureless compound image that may be decoded only with properly synchronized eyewear.

In these systems, to provide more enhanced security, the respective color components of the fundamental image may be encoded sequentially, thereby requiring more complicated synchronized variable color-filter decoding eyewear. Such systems are highly secure and do function to reduce irritating display flicker and eye strain, since at least one color component of the fundamental image is always displayed. However, such systems still utilize concepts of time multiplexing and, although they can be used with LCD's, are probably better suited for high speed conventional CRT displays at this time.

The LCD, however, due to its flat screen, thin profile, high resolution, and low power consumption, has become the display of choice for use with most portable laptop computers, where incidentally, the need for confidential viewing is likely to be the greatest. In this regard, some devices more specific to the LCD have been introduced which seek to provide confidential viewing by removing the top polarizing layer of the LCD screen. This renders the display “invisible” except to those wearing polarized glasses. U.S. Pat. No. 5,488,496, issued Jan. 30, 1996, discusses one such device. Although somewhat effective, this system of confidential viewing is vulnerable in that anyone wearing properly polarized glasses, even ordinary Polaroid glasses, can view the hidden image. Additionally, the screen is not easily converted between confidential and normal viewing modes. Other devices of this general type are believed to be disclosed in Japanese Patent Nos. 07084253 JP; 04107524 JP; 02116826 JP; and 05173127 JP.

With the limitations of the prior art, particularly with respect to the popular LCD, it is apparent that a better means is necessary for providing simple, low cost confidential viewing which can be used in all applications of full color/full motion graphics and images. Moreover, in order to better accommodate confidential viewing of today's LCD, it is desirous to accomplish this objective while avoiding the use of high speed time multiplexing techniques, or cumbersome, cost-intensive supplemental and/or wavelength-shifted masking light sources.

It is believed that my improved image altering apparatus and method as described hereafter accomplishes this end while minimizing the cost of implementation and greatly enhancing the viewing security of video displays today.

### BRIEF SUMMARY OF THE INVENTION

In accordance with the present invention, an apparatus and method are described herein for providing confidential viewing of a display image by utilizing techniques of spatial multiplexing image modification.

In general, the concept of spatially multiplexing images involves the process of geometrically combining a fundamental image with another image on an image display device. If combined with the appropriate image, spatial multiplexing image modification can be used for purposes of masking the fundamental image. A periodic (or random) array of squares, rows, columns, etc., may be removed from the fundamental image and substituted with corresponding sections of a masking image, thereby generating a combined image which obscures the fundamental image from view with the naked eye.

While it is contemplated that the masking image can be of any composition capable of rendering the fundamental image indecipherable, in one embodiment of my invention, the fundamental image is geometrically combined on an image display device with its true color-inverted image to produce a combined neutral image that appears substantially featureless to the naked eye. This is accomplished by spatially multiplexing fundamental and inverse image components on an image display device so as to associate with separate but closely adjacent display regions thereof. As used herein and throughout the appended claims, the term “adjacent,” when used in reference to the display regions of an image display device, is intended to mean nearby, but not necessarily having a common border.

These display regions to which the fundamental and inverse image components correspond are generally associated with, or may comprise, one or more pixels, or sub-pixels, of a static or dynamic image display device. As such, they are generally microscopic in size and are of sufficiently small compass that the human eye has difficulty distinguishing therebetween. The fundamental and inverse image components are therefore mixed, neutralizing the fundamental image and rendering it virtually invisible to the naked eye.

Creating such a-spatially multiplexed neutral image requires modification of the original fundamental image to incorporate the corresponding inverse image components. Generally, for each fundamental image component utilized, there is required a corresponding derived inverse image component; thus, each inverse image component requires displacement of an original fundamental image component from the fundamental image. The resulting combined image, then, is essentially comprised of a conglomeration of close, geometrically-intermixed corresponding fundamental and inverse image components that, when viewed as a whole with the naked eye, appears neutral and substantially featureless.

The multiplexed fundamental image components, albeit hidden from public view, are representative of the original fundamental display image. In order to provide confidential viewing of the fundamental image components, and thus the fundamental display image, the system is designed such that the display regions of the image display device with which the fundamental image components are associated are always cross-polarized (i.e., one polarization state blocks light admitted by the other) relative to the adjacent display regions with which the masking image components are associated. Thus, appropriately polarized eyewear matching the polarization state of the display regions with which the fundamental image components are associated will effectively block all masking image components and allow passage only of the fundamental image components for confidential viewing. While the combined multiplexed image renders the fundamental image indecipherable to the naked eye of the unintended viewer, an authorized viewer wearing the appropriately polarized eyewear will have full access to the fundamental image for confidential viewing.

Configuring the image display device with adjacent display regions of differing polarization states may be accomplished utilizing one of several techniques. In one embodiment, it is contemplated that a micropolarizing overlay or inlay having closely adjacent areas of differing polarization states be incorporated into the image display device. This may be accomplished using spatially alternating polarized filters, or by using alternating light retarders to rotate the polarization state of adjacent display regions. The micropolarizer is constructed and arranged such that the adjacent areas of different polarization align with various designated display regions/pixels of the image display device to alter the polarization state of such display regions to that of their correspondingly aligned areas of the micropolarizer.

In another embodiment, an electrically controllable polarizer can be incorporated in the image display device to alter the polarization state of the adjacent display regions. Such an electrically controllable polarizer may be used in static or dynamic display systems, and may take the form of a liquid crystal rotator added to the display configuration in such manner as to effectively rotate the polarization angle of transmitted light based on applied voltage thereto. For each display region of the image display device, the polarization angle can be set to rotate transmitted light either 0 or 90 degrees, depending on whether such display region is associated with fundamental or masking image components.

Utilizing an electrically controllable polarizer to alter the state of polarization of adjacent display regions offers certain advantages in enhanced security. With the ability to now change states of polarization of individual display regions of the image display device, it becomes possible to periodically or randomly alter the state of polarization of the display regions associated with the fundamental image components. Provided the polarized eyewear worn by the authorized viewer is synchronized to change states of polarization in unison with the display regions associated with the fundamental image components, the polarization of the eyewear will continue to match that of the fundamental image components, thereby enabling decoding of the fundamental image. In this embodiment, mere passive polarized eyewear may no longer be utilized to decode the fundamental image.

Notably, a similar effect may also be accomplished in an electronic display by periodically or randomly altering the display position of the fundamental image components to align with fixed areas of polarization different from that with which they were aligned in the previous display frame(s). In this embodiment, fundamental image components that are initially suppressed at pixel locations occupied by the masking image components are revived, and those fundamental image components previously displayed at other pixel locations become displaced by new masking image components. In this mariner, the physical display positions of the respective fundamental and masking image components are alternated or switched in synch with the display's refresh rate and in accordance with a predetermined or random sequence pattern.

Alternating the display positions of the fundamental and masking image components in this manner also has the distinct advantage of increasing image resolution by allowing recapture of the initially displaced fundamental image components. Rather than permanently displacing certain fundamental image components, adjacent fundamental image components may now be alternately displayed in any desired sequence, thereby allowing full resolution of the fundamental image to be restored.

Provided the polarized eyewear worn by the authorized viewer is synchronized to change states of polarization in unison with the change of position of the fundamental image components, the eyewear will still be polarized to match the display regions of the fundamental image components, thereby enabling same to be decoded. Again, mere passive polarized eyewear may no longer be utilized to decode the fundamental image.

Although less secure, it is also contemplated that the use of a variable polarizer could be combined to operate in synch with the alternating display positions of the fundamental image components, thereby providing a system that may be decoded using passive polarized eyewear with full resolution of the decoded fundamental image.

In the preferred embodiment where inverse image components are used to mask the fundamental image, more enhanced security may be obtained by adding to or incorporating as a part of the inverse image components overlay image components that are representative of a separate overlay image. By so doing, the fundamental image components are still neutralized by the corresponding inverse image components, but the general viewing public will now see a separate overlay image which may be either static or dynamic, such as in the case of a movie. The overlay image thus appears “on top” of the combined substantially featureless image, thereby deceiving unintended viewers into believing that a different image is being viewed by the system operator. However, since the overlay image components are incorporated as part of the inverse image components, they too will be blocked from the view of the authorized viewer wearing the appropriately polarized eyewear matching the polarization state of the display regions associated with the fundamental image components.

Although the above illustrations are exemplary of various means by which an image display device may be configured with closely adjacent display regions of differing polarization states, it is contemplated that any means of addressing different polarization states to adjacent display regions of the image display device may be utilized for purposes of implementing this invention.

As can be seen by the foregoing, through modification of the fundamental image, corresponding fundamental and masking image components may be spatially multiplexed for display in association with adjacent but cross-polarized display regions of an image display device. From this, with little or no display flicker, a highly secure combined image may be generated that will render the fundamental image indecipherable to the naked eye.

With appropriately polarized eyewear, this combined image may be demultiplexed for confidential viewing of the fundamental image. This is accomplished without the need for high speed multiplexing of image signals, or cumbersome, cost-intensive supplemental and/or wavelength-shifted masking light sources.

### BRIEF DESCRIPTION OF THE DRAWINGS

These and other objects and advantages of the invention will more fully appear from the following description, made in connection with the accompanying drawings, wherein like reference characters refer to the same or similar parts throughout the several views, and in which:

FIG. 1 is a diagrammatic representation of an image display device showing the manner in which such a device may be represented as a matrix of individual display regions (enlarged for ease of illustration) that are associated with distinct image components displayed at various pixel locations, or groups thereof, on the image display device;

FIG. 2A is a similar diagrammatic representation of an image display device showing corresponding fundamental and inverse image components spatially multiplexed in a checkerboard arrangement of display regions so as to provide an encoding scheme which produces a substantially featureless image to the naked eye;

FIG. 2B is a similar diagrammatic representation of an image display device showing corresponding fundamental and inverse image components spatially multiplexed in a row-by-row arrangement of display regions so as to provide an encoding scheme which produces a substantially featureless image to the naked eye;

FIG. 2C is a similar diagrammatic representation of an image display device showing corresponding fundamental and inverse image components spatially multiplexed in a column-by-column arrangement of display regions so as to provide an encoding scheme which produces a substantially featureless image to the naked eye;

FIG. 3A is a diagrammatic representation of the image display device shown in FIG. 2A, where corresponding fundamental and inverse image components are spatially multiplexed in a checkerboard arrangement, and polarization encoding is utilized to make each display region associated with a fundamental image component cross-polarized relative to the display region associated with its corresponding inverse image component;

FIG. 3B is a diagrammatic representation of the image display device shown in FIG. 2B, where corresponding fundamental and inverse image components are spatially multiplexed in a row-by-row arrangement, and polarization encoding is utilized to make each display region associated with a row of fundamental image components cross-polarized relative to the display region associated with the adjacent row of corresponding inverse image components;

FIG. 3C is a diagrammatic representation of the image display device shown in FIG. 2C, where corresponding fundamental and inverse image components are spatially multiplexed in a column-by-column arrangement, and polarization encoding is utilized to make each display region associated with a column of fundamental image components cross-polarized relative to the display region associated with the adjacent column of corresponding inverse image components;

FIG. 4 is a diagrammatic representation of an image display device, such as an LCD, incorporating a micropolarizing overlay having row-by-row alternating cross-polarized areas aligned with alternating display region rows associated with corresponding fundamental and inverse image components being displayed thereon;

FIG. 5 is a diagrammatic representation of an image display device, such as an LCD, incorporating an alternative micropolarizing overlay in the form of a ½λ retarder plate which has row-by-row alternating cross-polarized areas aligned with alternating display region rows associated with corresponding fundamental and inverse image components being displayed thereon;

FIG. 6 is a diagrammatic representation of an image display device, such as an LCD, incorporating an electronically controllable polarizer for altering states of polarization between adjacent display regions associated with corresponding fundamental and inverse image components arranged in a row-by-row display configuration;

FIG. 7 is a diagrammatic representation of alternating first and second display frames of an image display device utilizing an alternate encoding scheme whereby a fixed polarizing overlay is used in combination with varying display positions of fundamental and inverse image components, thereby requiring active polarized eyewear to decode the fundamental image;

FIG. 8 is a diagrammatic representation of alternating first and second display frames of an image display device utilizing still another alternate encoding scheme whereby corresponding fundamental and inverse image components are time multiplexed with one another, and a fixed polarizing overlay is used in combination with varying display positions of fundamental and inverse image components, thereby requiring active polarized eyewear to decode the fundamental image; and

FIG. 9 is a test image encoding breakdown showing the principles of the encoding scheme described in reference to FIG. 8, wherein spatial multiplexing and time multiplexing techniques are combined to vary the polarization states of fundamental image components over time and recapture full resolution of the fundamental image upon decoding thereof using active polarized eyewear.

### DETAILED DESCRIPTION OF THE INVENTION

The present invention, as described and claimed herein, utilizes principles of spatial multiplexing image modification to provide for secure confidential viewing of a display image. While the concepts set forth herein are generally applicable to either electronic or printed images, the following discussion shall focus primarily on electronic images, such as those found on video displays. It shall be understood, however, that print media may be modified upon printing, using these same spatial multiplexing techniques, to mask a fundamental image from unauthorized viewing and provide for confidential viewing only by an intended viewer.

In order to better describe my invention, it is helpful to first explain briefly the concept of “primary color addition” as it pertains to light produced by video displays, and the response of the human eye with respect to the same. Virtually all common video displays, from color television and CRT displays, to LCD screens, plasma displays, etc., generate an image through the additive mixture of three primary colors of light: red; blue; and green. A video display typically has thousands of tiny areas, called pixels, that produce light of a specific color representative of an image at that specific location. Each pixel, in turn, is generally composed of a triad of smaller areas, or sub-pixels, consisting of tiny phosphors, color filters, or the like, which individually produce the primary colors red, blue, and green.

As one views a color image produced on a video display, the human eye does not detect each red, green, or blue sub-pixel separately. Rather, depending on the intensity of each primary color component, the color sensitive cones within the human eye react to the primary colors, such that one viewing the video display will see a range of many colors combined to produce the desired complete image. Thus, depending upon the varying intensities of light produced by each sub-pixel, the corresponding pixel will produce a composite light that appears as a different color to the human eye. If the intensities of all red, blue, and green components of a given pixel are the same, the human eye will perceive that the pixel produces a neutral white light. Nearly all electronically reproducible images are constructed in this manner.

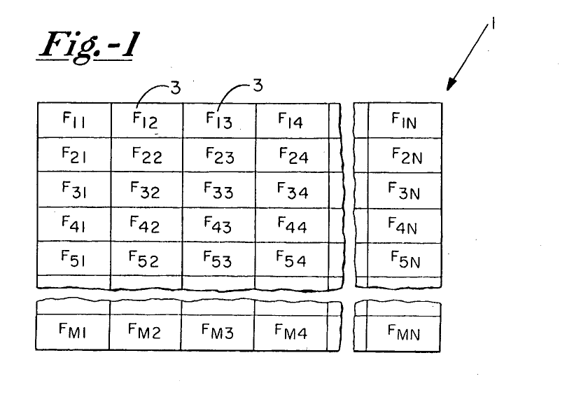

For purposes of further discussion herein, as shown in FIG. 1, it is convenient to visualize an image display device 1, such as an electronic display, as a matrix of display regions 3, wherein each display region is associated with, and may comprise, one or more pixel locations, or groups of pixel locations (i.e., rows, columns, etc.) associated with distinct image components being displayed on the image display device. As seen in FIG. 1, a fundamental image may therefore be represented as a plurality of distinct fundamental image components F₁₁-F_{MN}, where subscripts “M” and “N” represent the specific pixel(s) location, by row and column, respectively, of that particular component. It will be appreciated that individual image components/pixels referenced throughout the accompanying drawings are shown grossly enlarged for ease of illustration. In an actual image display device 1, such as an LCD, the boundaries between adjacent components/pixels are nearly indistinguishable to the naked eye.

With reference to the instant invention, providing confidential viewing of a fundamental image through spatial multiplexing image modification involves the process of geometrically combining the fundamental image with another image for purposes of masking the fundamental image. A periodic (or random) array of squares, rows, columns, etc., may be removed from the fundamental image and substituted with corresponding sections of the masking image, thereby generating a combined image which obscures the fundamental image from view with the naked eye. When the images are constructed of pixels, this combining of images can be on either a pixel by pixel basis, or by groups of pixels.

While it is certainly contemplated that the masking image can be of any composition, it is preferred that it be derived from the original fundamental image, as in the case of an inverse image. An inverse image is one that, when combined with its fundamental image, yields a neutral and featureless image When spatially multiplexing a fundamental image with its inverse image, pixels of the fundamental image are spatially multiplexed with pixels of the inverted image.

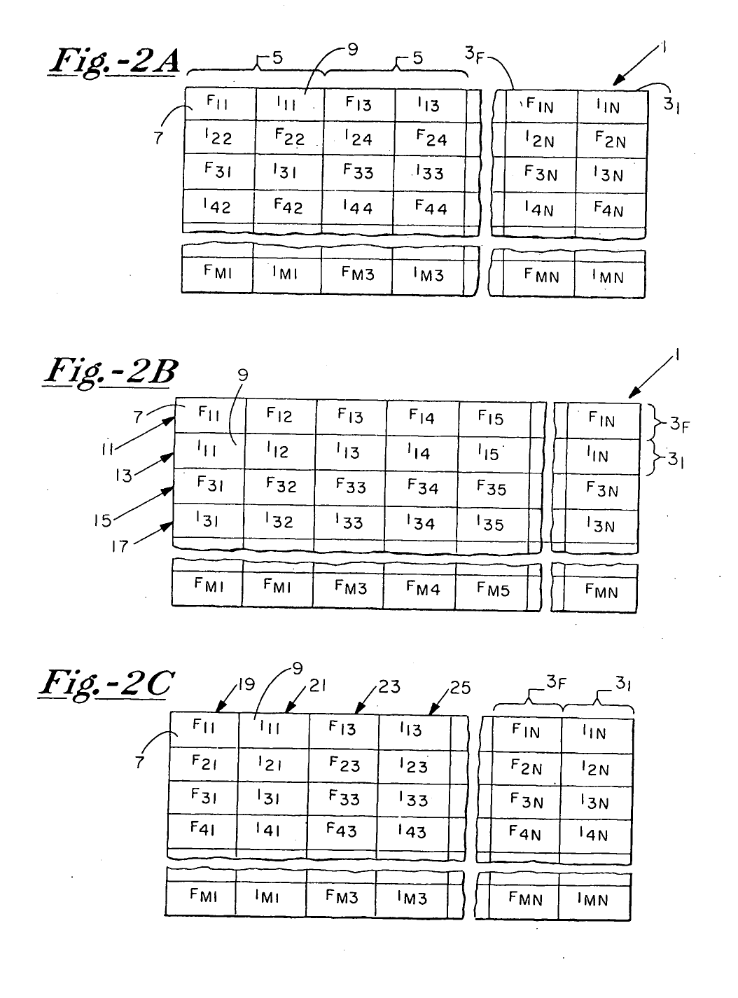

This is perhaps shown best in FIGS. 2A, 2B and 2C where, in accordance with one embodiment of this invention, fundamental image pixels of a fundamental image are shown spatially multiplexed with corresponding inverse image pixels derived therefrom. With specific reference to FIG. 2A, it can be seen that such pixel pairs 5, each representing a distinct pair of corresponding fundamental and inverted image components, may be arranged for display on an image display device 1 in a checkerboard fashion. Alternatively, groups of pixels associated with corresponding fundamental and inverse image components may be arranged by pixel rows (FIG. 2B), pixel columns (FIG. 2C), or even randomly distributed provided the distance between pixel pairs is not too great. Ideally, however, the pixels of each pair 5 are directly adjacent to each other.

Creating such a spatially multiplexed image requires modification of the original fundamental image to incorporate the corresponding masking image components. With reference to the preferred embodiment utilizing inverse image components, for each fundamental image component (F) utilized, there is required a corresponding derived inverse image component (I); thus, each inverse image component requires displacement of an original fundamental image component from the fundamental image.

This modification of the fundamental image can be seen in FIGS. 2A-2C. In FIG. 2A, each pixel location of display 1 represents a separate display region 3_{F} or 3_{I} for a fundamental or inverse image component, respectively, arranged in a checkerboard fashion. In this arrangement, F₁₁ denotes the fundamental image component associated with the pixel 7 located at row 1, column 1 of the image display device 1. The corresponding inverse image component I₁₁ of fundamental image component F₁₁ is positioned directly adjacent thereto at pixel location 9, and in this case has positionally displaced what normally would constitute original fundamental image component F₁₂ (see FIG. 1). This pattern continues throughout the image display device 1, thereby causing every other fundamental image component to be substituted with a corresponding inverse image component of an adjacently displayed fundamental image component. The resulting combined image, then, is essentially comprised of a conglomeration of close, geometrically-intermixed corresponding fundamental and inverse image components that, when viewed as a whole with the naked eye, appears neutral and substantially featureless.

In FIG. 2B, alternating pixel rows now define the associated display regions 3_{F} and 3_{I} of the corresponding fundamental and inverse image components. In this case, the fundamental image components F₁₁-F_{1N} are displayed in the first pixel row 11 of the image display device. The corresponding inverse image components I₁₁-I_{1N}, which are derived from fundamental image components F₁₁-F_{1N}, are then displayed immediately therebelow in the second row of pixels 13, thus displacing the original fundamental image components F₂₁-F_{2N} at such locations. Similarly, fundamental image components F₃₁-F_{3N} are displayed in the third row of pixels 15, and their corresponding inverse image components I₃₁-I_{3N} have displaced the original fundamental image components F₄₁-F_{4N} in the fourth row of display pixels 17. Again, this pattern continues throughout the image display device 1 to create an array of alternating rows of closely adjacent corresponding fundamental and inverse image components that, when viewed by the naked eye, will combine to appear neutral and substantially featureless.

In much the same manner, in FIG. 2C, alternating pixel columns of the image display device 1 now comprise the associated display regions 3_{F} and 3_{I} of the corresponding fundamental and inverse image components. In this case, the fundamental image components F₁₁-F_{M1} are displayed in the first pixel column 19 of the image display device. The corresponding inverse image components I₁₁-I_{M1}, which are derived from fundamental image components F₁₁-F_{M1}, are then displayed immediately adjacent thereto in the second column of pixels 21, thus displacing the original fundamental image components F₁₂-F_{M2} at such locations. Similarly, fundamental image components F₁₃-F_{M3} are displayed in the third column of pixels 23, and their corresponding inverse image components I₁₃-I_{M3} have displaced the original fundamental image components F₁₄-F_{M4} in the fourth column of display pixels 25. As can be seen in FIG. 2C, this pattern continues throughout the image display device 1 to create an array of alternating columns of closely adjacent corresponding fundamental and inverse image components that, when viewed by the naked eye, will also combine to appear neutral and substantially featureless.

In the above examples, the particular selection and arrangement of fundamental and inverse image components within the image display device 1 is not critical, provided the corresponding components are sufficiently close that the combined image adequately masks the fundamental image. Thus, it is conceivable that the display regions 3_{F} associated with fundamental image components may be periodically or randomly distributed, or comprise either odd or even rows or columns of pixels, provided the display regions 3_{I} with appropriate derived inverses thereto are adjacently located so as to be perceived by the naked eye as a combined substantially featureless image.

If utilizing inverse image components to mask the fundamental image, the intensity for each inverted sub-pixel corresponding to each sub-pixel in the fundamental image is calculated from;

I_{MAX}−I_{FUND}=I_{INV},

where I_{MAX} represents the maximum intensity of the particular sub-pixel in question, either red, green, or blue; I_{FUND} represents the intensity of the particular fundamental sub-pixel in question; and I_{INV} is the required intensity for the inverted sub-pixel in question. It will be appreciated that such calculation and modification of the fundamental image can be accomplished internally within an electronic display device using techniques well known in the art.

The combined, or multiplexed, image will now have the overall intensity of;

I_{FUND}+I_{INV}=50% Gray,

and appear uniformly neutral and featureless.

In the foregoing illustrations, the multiplexed fundamental image components, albeit hidden from public view, are representative of the original fundamental display image. In order to provide confidential viewing of the fundamental image components, and thus the fundamental display image, polarization encoding is utilized to block the masking image components from the sight of the authorized viewer, thereby effectively extracting the fundamental image. Since it is deemed preferable to use fundamental inverse image components as the masking image components, the following discussion will focus on this embodiment. It will be understood, however, that the principles of polarization encoding discussed herein are not limited to this embodiment, or dependant in any way on the composition of the masking image components.

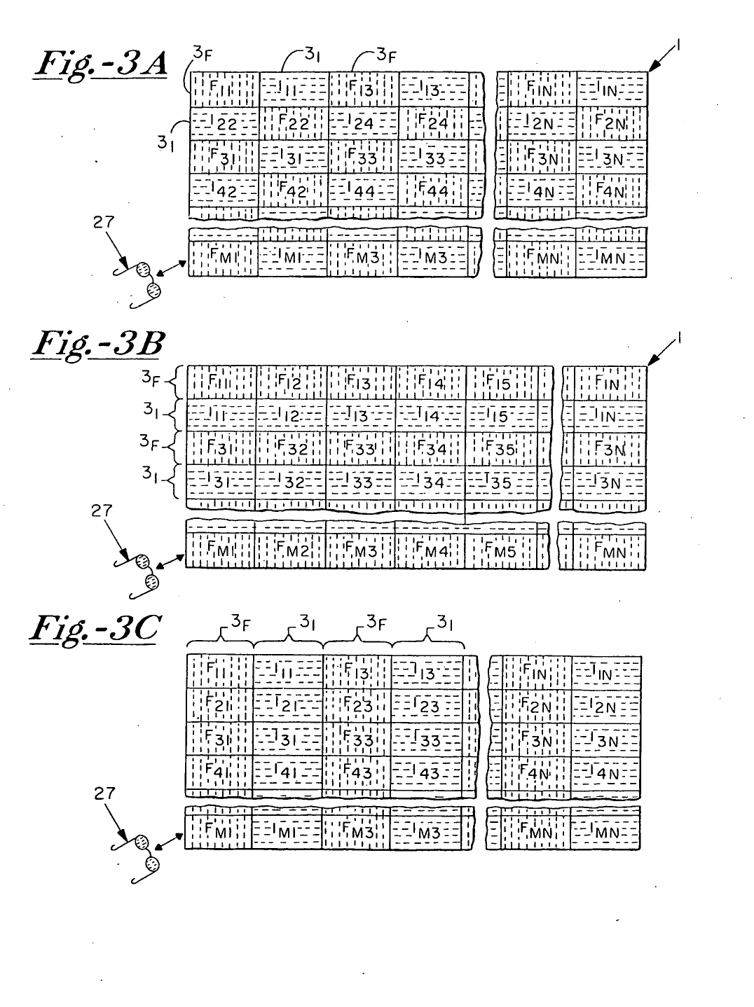

As shown in FIGS. 3A-3C, this system is designed such that the display regions 3_{F} of the image display device 1 with which the fundamental image components are associated are always cross-polarized relative to the adjacent display regions 3_{I} with which the inverse image components are associated. In FIG. 3A, where the display regions 3_{F} and 3_{I} correspond to alternating individual fundamental and inverse pixels arranged in a checkerboard fashion, all “fundamental” display regions 3_{F} are shown vertically polarized, whereas all “inverse” display regions 3_{I} are shown horizontally polarized. Similarly, in FIG. 3B, where the display regions 3_{F} and 3_{I} correspond to alternating fundamental and inverse pixel rows, it is seen that all “fundamental” rows 3_{F} are vertically polarized, and all “inverse” rows 3_{I} are horizontally polarized. Finally, as shown in FIG. 3C, alternating pixel columns may also be used to define the associated display regions 3_{F} and 3_{I} of the corresponding fundamental and inverse image components. In this system, the “fundamental” columns 3_{F} are shown vertically polarized, whereas the “inverse” columns 3_{I} are shown horizontally polarized.

Of course, it will be appreciated that it makes no difference how the respective display regions 3_{F} and 3_{I} are polarized, provided that they are cross-polarized relative to each other. Thus, if the display region 3_{F} associated with each fundamental image component is polarized in one orientation, and the display region 3_{I} associated with each inverted image component is polarized in an orthogonal orientation, the fundamental image may be easily extracted, or decoded, by viewing the combined image through appropriately polarized eyewear 27 constructed to match the state of polarization of the fundamental image components. In this way, the fundamental image can only be discerned by those wearing the appropriate eyewear 27.

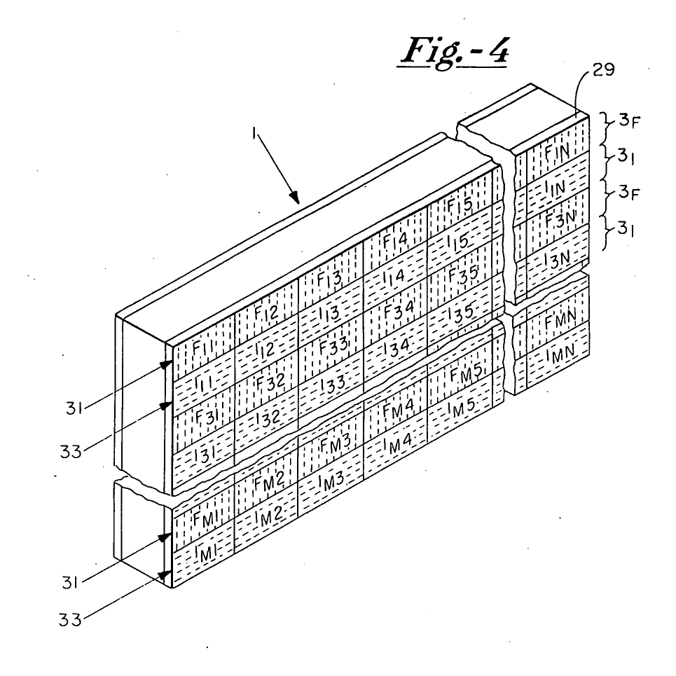

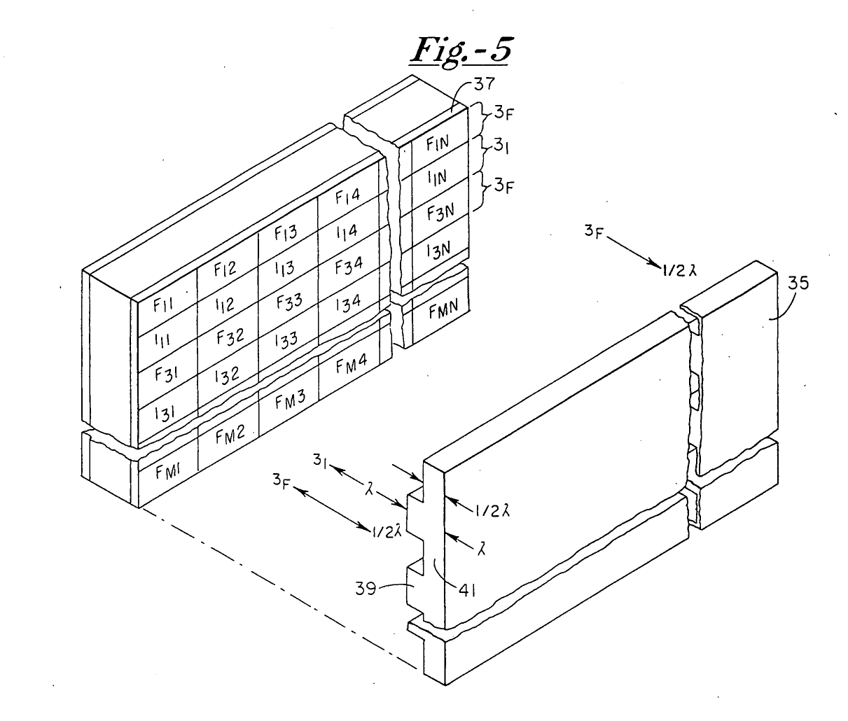

Configuring the image display device with adjacent display regions of differing polarization states may be accomplished by either incorporating appropriate polarizers directly within the display pixels of an image display device 1, or by applying polarizing overlays thereto. In one embodiment, as shown in FIG. 4, it is contemplated that a micropolarizing overlay 29 having closely adjacent areas 31, 33 of differing polarization states be incorporated into an image display device 1, such as an LCD. In this embodiment, the front or top polarizing layer of the LCD is actually removed and replaced with the new transparent micropolarizing overlay 29, which in this case is configured for row by row cross-polarizing alignment. As shown in FIG. 4, each distinct display region of the modified LCD panel incorporating overlay 29 is now associated with one or more rows of either “fundamental” image pixels or “inverse” image pixels, where each display region 3_{F} effectively after the polarization states of adjacent display regions 3_{F} and 3_{I} associated with corresponding fundamental and inverse image components. In this embodiment, as shown in FIG. 5, the standard front polarizer 37 of the LCD need not be removed. Instead, the micropolarizer 35 is constructed as a ½λ phase retarding overlay plate which, in this case, incorporates alternating rows 39, 41 of etched λ and ½λ steps that align with alternating rows of corresponding fundamental and inverse image component display regions 3_{F} and 3_{I}.

The ½λ retarder plate 35 can be laminated to the standard front polarizer 37 of the LCD panel 1 and properly aligned to effectively rotate the polarization state of alternating pixel rows or display regions 3_{F} and 3_{I} associated with the fundamental and inverse image components on the LCD panel. In the embodiment shown in FIG. 5, it is seen that light emitted from each “fundamental” pixel row or display region 3_{F} of the LCD panel 1 passes through a ½λ phase retardation 41, thereby shifting the polarization state of such light and associated fundamental image components by 90 degrees. Light emitted from each “inverse” pixel row or display region 3_{I}, on the other hand, passes through a λ phase retardation 39, thus leaving its initial polarization unaltered and cross-polarized relative to each of the display regions 3_{F} associated with the fundamental image components. Additionally, it is also contemplated that the micropolarizer may employ circular polarization, rather than linear. In the embodiment of FIG. 5, this may be accomplished by adjusting the plate thickness of the retarder 35 to cause right-hand circular polarization of one set of display regions (i.e., 3_{F}), and left-hand polarization of the other display regions (i.e., 3_{I}). Circular polarization eliminates crosstalk effects which occur if the users head is tilted while viewing through the polarized eyewear. With circular polarization, the head may be freely tilted without penalty.

Of course, it will be appreciated that the micropolarizers 29, 35 described in the above embodiments could equally well be constructed for column by column cross-polarizing alignment, pixel by pixel cross-polarizing alignment, or randomly, as previously suggested. So long as the areas of the micropolarizer that are aligned with the fundamental image pixels are polarized in a common state of polarization that is orthogonal or otherwise cross-polarized relative to the areas of the micropolarizer aligned with the inverse image pixels, appropriate eyewear 27 passively polarized to match the polarization state of those areas of the micropolarizer that are aligned with the fundamental image pixels may be used to decode the fundamental image.

It is noted that the use of a micropolarizer 29 having alternating polarized filters as in FIG. 4, though effective, may not be as easily produced as the micropolarizer 35 incorporating the alternating retarders shown in FIG. 5. Also, although it is contemplated that the present invention may be utilized with all print and electronic image display devices 1, with respect to electronic displays, the micropolarizers discussed herein are likely to be better suited for use in connection with LCD panels, as the LCD display panel utilizes fixed pixel spacing and is more adaptable to overlays than say CRT's, which do not have as accurate control of individual pixel locations.

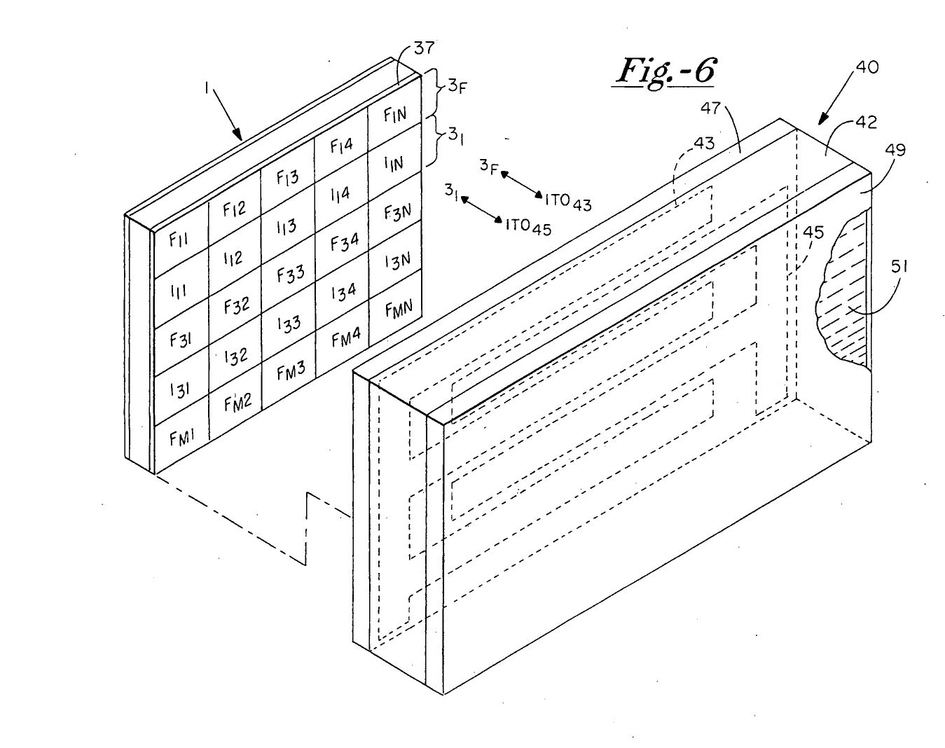

In another embodiment, as shown in FIG. 6, an electrically controllable polarizer 40 can be incorporated in the image display device 1 to alter the polarization state of the adjacent display regions 3_{F} and 3_{I} associated with the corresponding fundamental and inverse image components. Such an electronic polarizer 40 may be used in static or dynamic display systems, and may take the form of a liquid crystal rotator added to the display configuration in such manner as to effectively rotate the polarization angle of transmitted light based on applied voltage thereto.

In this embodiment, a second liquid crystal (LC) layer 42 is laminated to the front panel 37 of the LCD. This second LC layer 42 may be fabricated using known methods in the art, similar to the LCD, and is constructed having two electrically addressable zones 43 and 45. As shown in FIG. 6, these electrically addressable zones 43 and 45 are constructed from transparent electrodes, such as indium tin oxide electrodes (ITO), configured in alternating rows on the inner and/or outer substrates 47 and 49 of the second LC layer 42.

Preferably, as shown in FIG. 6, one substrate 47 will carry alternating ITO rows, with every odd row being interconnected as one electrically addressable zone 43, and every even row being interconnected as the second electrically addressable zone 45. The other substrate 49 may then be configured either as a common ground for both addressable zones, or separated with matching alternating ITO rows. In the example shown in FIG. 6, the inner substrate 47 is shown carrying both addressable zones, and the outer substrate 49 acts as a common ground.

Suspended between the inner and outer substrates 47 and 49 is the crystalline liquid 51, and depending on the voltage applied to the respective zones, the light passing through the crystalline liquid 51 at such location may be rotated so as to effect a change in polarization thereof. In FIG. 6, the first addressable zone 43 comprising the odd ITO rows is aligned with groups of “fundamental” pixel rows, while the second addressable zone 45 comprising the even ITO rows is aligned with groups of corresponding “inverse” pixel rows. Thus, by applying the appropriate voltage to either the first or second addressable zone of the second LC layer, the adjacent display regions 3_{F} and 3_{I} associated with the corresponding fundamental and inverse image components may be effectively cross-polarized relative to one another.

Notably, in FIG. 6 the electronically addressable zones 43 and 45 are configured as alternating rows, but it is readily apparent that these zones can also be arranged in columns, in a checkerboard pattern, or randomly, to match the pattern of display regions 3_{F} and 3_{I} associated with the respective fundamental and inverse image components. Depending on the pattern used, the second LC layer 42 may be made to the exact same dimensions for perfect alignment. The LC layer 42 acts as an electrically controllable retarder, providing precise polarization control to the selected underlying pixels of the LCD 1. For each display region 3_{F} or 3_{I} of the image display device 1, based on applied voltage thereto, the polarization angle can be set to rotate transmitted light either 0 or 90 degrees, depending on whether such display region is associated with fundamental or inverse image components.

Although the aforementioned embodiments do provide for secure viewing of the fundamental image, they are secure only to the point of having the appropriate passive eyewear 27. More specifically, anyone wearing eyewear passively polarized to the same state of polarization as the display regions 3_{F} associated with the fundamental image components would be able to decipher the underlying fundamental image. There are circumstances, however, where it is desirable to provide a higher level of security and a more confidential viewing environment.

One means of providing for enhanced security is to vary the polarization states of adjacent display regions 3_{F} and 3_{I} using the electrically controllable polarizer 40 described in FIG. 6 above. Since the rotation of light can now be electrically controlled, it can be used to alter over time the state of polarization of the respective display regions 3_{F} and 3_{I} associated with the addressable zones 43 and 45 of the second LC layer 42. From this, it becomes possible to periodically or randomly vary the state of polarization of the display regions 3_{F} associated with the fundamental image components.

Provided the polarized eyewear worn by the authorized viewer is synchronized to change states of polarization in unison with the display regions 3_{F} associated with the fundamental image components, the polarization of the eyewear will continue to match that of the display regions 3_{F} associated with the fundamental image components, thereby enabling decoding of the fundamental image. In this embodiment, mere passive polarized eyewear may no longer be utilized to decode the fundamental image, and thus security is enhanced.

A higher level of security may also be obtained using active polarized eyewear in combination with the passive micropolarizer overlays 29, 35 previously described. To accomplish this, pixel position on an electronic display device can actually be made to alternate between display frames. In other words, the display position of the fundamental image components may be periodically or randomly altered to align with fixed areas of polarization different from that with which they were aligned in the previous display frame(s).

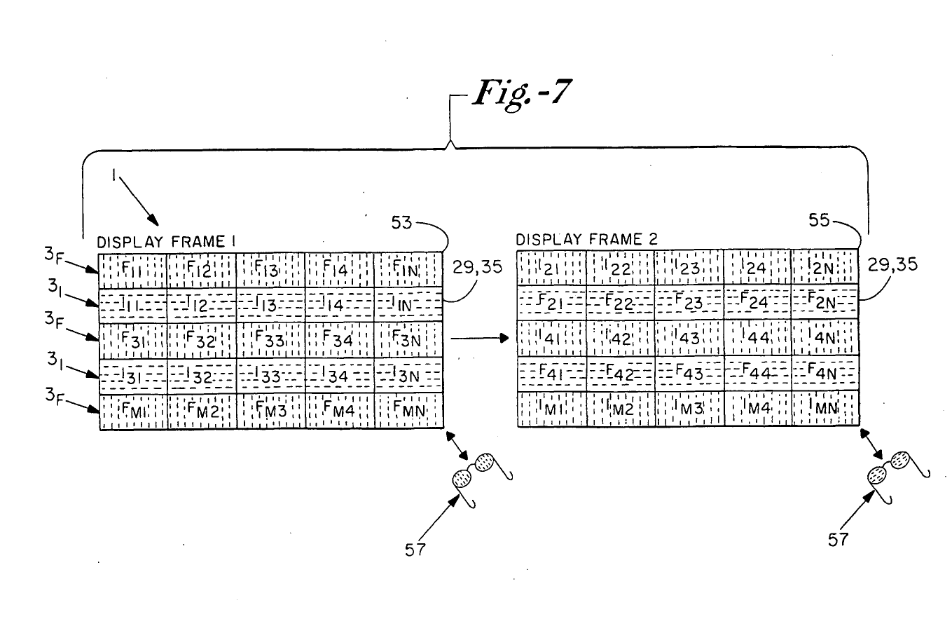

For example, shown in FIG. 7 is the display screen of an electronic image display device 1 incorporating a passive micropolarizer overlay 29 or 35. In the first frame 53, it is seen that the fundamental image pixels are displayed in odd rows using vertical polarization, and the corresponding inverted image pixels are displayed in even rows using horizontal polarization. In the next frame 55, the fundamental image pixels switch to the even rows using horizontal polarization, and the inverted image pixels switch to the odd rows using vertical polarization. The alternation between polarization states can be periodic or random. If the average time at each polarization state is the same, anyone wearing passive polarized eyewear would see equal amounts of both fundamental and inverted images, yielding a neutral and substantially featureless display.

Notably, in this embodiment, fundamental image components that are initially suppressed at pixel locations occupied by inverse image components are revived, and those fundamental image components previously displayed at other pixel locations become displaced by new inverse image components derived from the revived fundamental image components. This can be seen in FIG. 7. In the first display frame 53, the fundamental image components F₁₁-F_{1N} are present in the top row pixels, and the corresponding derived inverse image components I₁₁-I_{1N} are present in the second row pizels, thereby displacing the original second row fundamental image components F₂₁-F_{2N} (see, FIG. 1). In the next display frame 55, however, fundamental image components F₂₁-F_{2N} are revived. The corresponding derived inverse image components I₂₁-I_{2N} now appear in the top row pixel locations, displacing the initial fundamental image components F₁₁-F_{1N}. Thus, over time the physical display positions of the corresponding fundamental and inverse image components are alternated or switched in synch with the display's refresh rate and in accordance with a predetermined or random sequence pattern.

In order to decode the fundamental image in this case, active polarized eyewear 57 is required. These incorporate electrically variable polarizers synchronized with the display device 1. When the fundamental image components are horizontally polarized, so are the glasses, and when the fundamental image components switch to vertical polarization, so do the glasses. In this way, the intended viewer sees only the fundamental image, while all others see nothing. The active eyewear 57 can be made wireless as well, and also made to incorporate unique identification codes so that other active eyewear is unable to synchronize.

Another advantage of this active eyewear approach is recovered resolution. In previous embodiments, one half of the fundamental image data or pixels were suppressed to allow room for the inverse image components. For most applications, the typical resolution of an LCD screen is more than sufficient to accommodate this loss. But, for high resolution applications, it may be desirable to have full resolution, as well as a secure viewing environment. In the embodiment of FIG. 7, resolution is fully restored through persistence of vision. In the first display frame 53, the fundamental image was taken from all the pixels which were vertically polarized, with the inverted image being derived from these. In the second display frame 55, the fundamental image is taken from the locations which were previously occupied by the inverted image, and the inverted image pixels are now calculated from these. In this way, all fundamental image components are recaptured over time. Therefore, the fundamental image will be randomly composed of its entire data set, and through persistence of vision, the fundamental image will appear fully restored.

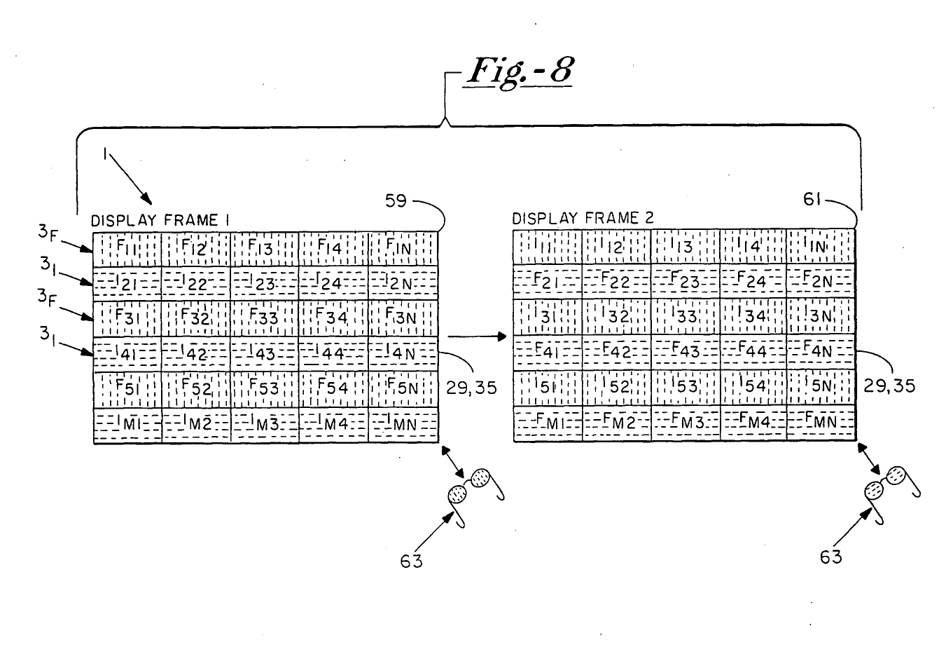

In still another more secure and preferable embodiment of my invention, principles of both spatial and time multiplexation can be combined to create an image encoding scheme that provides a highly secure and confidential viewing environment. As shown in FIG. 8, this too is accomplished using an electronic display device 1 with a passive micropolarizer overlay 29 or 35. Once again, grouping image components by pixel rows for purposes of illustration, it is seen that in the first display frame 59, every odd row of pixels comprise fundamental image components associated with that specific row (i.e., F₁₁-F_{1N}; F₃₁-F_{3N}, etc.). Every even row of pixels, on the other hand, comprise inverse image components derived from the original fundamental image components associated with that specific row (i.e., I₂₁-I_{2N}; I₄₁-I_{4N}, etc.). Thus, each “fundamental” pixel row is spatially multiplexed with an adjacent “inverse” pixel row, albeit the inverse of the adjacent row of fundamental image components. While the inverse image components are not derived from the fundamental image components displayed directly adjacent thereto, they are likely to be a close approximation given the relatively gradual change in the overall color scheme of the fundamental image in comparison to the miniscule distance between adjacent pixels.

In the second display frame 61, all image components of the first display frame 59 are inverted. Thus, all odd rows of pixels now comprise the corresponding inverse image components of the original fundamental image components associated with that specific row (i.e., I₁₁-I_{1N}; I₃₁-I_{3N}, etc.). Likewise, all even rows of pixels now comprise fundamental image components associated with that specific row (i.e., F₂₁-F_{2N}; F₄₁-F_{4N}, etc.). As this inversion process continues over time, every fundamental image component at each pixel location is not only spatially multiplexed with an adjacent approximate inverse image component, but is also time multiplexed with its corresponding derived inverse image component. As in previous embodiments, it is contemplated that those pixels or groups of pixels associated with corresponding fundamental and inverse image components may be arranged by pixel rows (as shown), pixel columns, or even randomly distributed, as previously described.

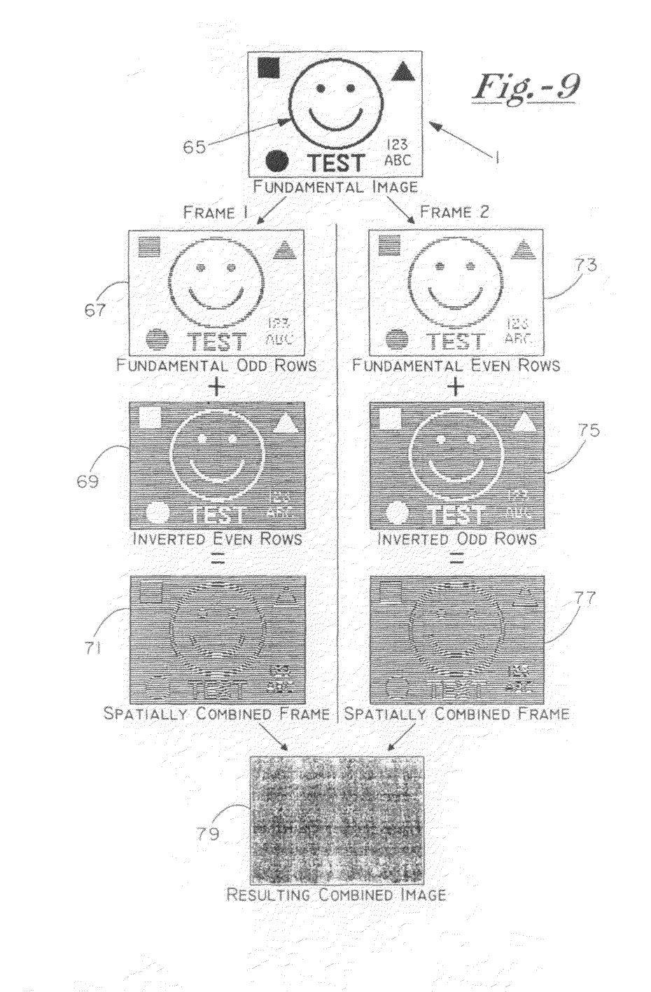

Implementation of the encoding scheme in FIG. 8 can be best seen by reference to the test image encoding breakdown shown in FIG. 9. As shown therein, a fundamental test image 65 comprising a happy face, geometric figures and textual matter may be represented as two display frames (Frame 1 and Frame 2) alternating in time on a typical electronic image display device 1. The first display frame (Frame 1) of the fundamental image 65 is shown further broken down into a display 67 of “odd row” fundamental image components (i.e., F₁₁-F_{1N}; F₃₁-F_{3N}, etc.) and a display 69 of “even row” inverse image components (i.e., I₂₁-I_{2N}; I₄₁-I_{4N}, etc.) which, when combined, creates a relatively obscure spatially combined image 71 of fundamental and inverse image components.

The second display frame (Frame 2) of the fundamental image 65 is shown further broken down into a display 73 of “even row” fundamental image components (i.e., F₂₁-F_{2N}; F₄₁-F_{4N}, etc.) and a display 75 of “odd row” inverse image components (i.e., I₁₁-I_{1N}; I₃₁-I_{3N}, etc.) which, when combined, creates another relatively obscure spatially combined image 77 of fundamental and inverse image components that is the true inverse of the spatially combined image 71 of the first display frame.

Since the spatially combined images 71 and 77 are the true inverses of one another, alternating such images over time generates a resulting combined image 79 that appears substantially featureless and neutral to the naked eye, thereby masking the fundamental image from the sight of all unauthorized viewers. As described previously in connection with FIG. 7, decoding of the fundamental image may be effected using similar active polarized eyewear 63, thus providing for enhanced security. Because fundamental image components align with different display regions 3_{F} during successive display frames (i.e., even versus odd pixel rows), synchronized eyewear 63 can be made to alter states of polarization to match the polarization state of the display regions 3_{F} associated with the fundamental image components currently being displayed.

Also, as in the embodiment of FIG. 7, such multiplexing of the fundamental and inverse images in FIGS. 8 and 9 may occur in accordance with a predetermined or random sequence pattern. Provided the average time at each polarization state is the same, anyone wearing passive polarized eyewear would still see equal amounts of both fundamental and inverted images, yielding a neutral and substantially featureless display. Moreover, as in the embodiment of FIG. 7, full resolution of the fundamental image will be completely restored through persistence of vision, as all fundamental image components are recaptured over time.

Although less secure, it is also contemplated that the use of an electrically controllable polarizer 40 as described in FIG. 6 could be combined with the systems of either FIG. 7 or FIG. 8 to operate in synch with the alternating display positions of the fundamental image components, thereby providing a system that may be decoded using passive polarized eyewear with full resolution of the decoded fundamental image. This may be advantageous in applications where a lower level of security is acceptable, but high resolution is required.

To provide an even more secure environment, overlay or misleading images may be incorporated. In systems utilizing masking inverse image components, such overlay components may be simply added to the derived inverse image components. Thus, casual observers will see something other than neutral gray, and something entirely different than the fundamental image. Since the overlay image components are incorporated as part of the displayed inverse image components, the dynamic range of the inverse image components must be compressed to allow for the addition of the overlay image. Consequently, in order to maintain neutrality of the background to the overlay image, the dynamic range of all corresponding fundamental image components must also be compressed proportionately to account for the addition of the overlay image. In other words, the dynamic range of the fundamental image must be reduced by the dynamic range of the overlay image to maintain complete masking of the fundamental image. With the overlay image components being added to the inverse image components, they too will be blocked from the view of an authorized viewer wearing the appropriately polarized eyewear matching the polarization state of the display regions associated with the fundamental image components.

When applied to print media, confidential images may be embedded within other misleading images. In much the same way as described above, the fundamental image pixels and the inverted image pixels are printed and then laminated with a micropolarized overlay. Now, viewing the fundamental image is only possible while wearing the appropriate eyewear.

As can be seen by the foregoing, through modification of the fundamental image, fundamental and masking image components may be spatially multiplexed for display in association with adjacent but cross-polarized display regions of an image display device. By utilizing masking “inverse” image components, a highly secure combined image may be generated that will appear neutral and substantially featureless to the naked eye, and if desired, misleading overlay images may be incorporated. With appropriately polarized eyewear, this combined image may be demultiplexed for confidential viewing of the fundamental image. As shown, this may be accomplished without the need for high speed multiplexing of image signals, or cumbersome, cost-intensive supplemental and/or wavelength-shifted masking light sources.

It will, of course, be understood that various changes may be made in the form, details, arrangement and proportions of the parts without departing from the scope of the invention which comprises the matter shown and described herein and set forth in the appended claims.

1. An apparatus for confidential viewing of a fundamental image utilizing spatial multiplexing image modification, comprising:
(a) an image display device comprising a plurality of adjacent display regions of different polarization states.
(b) a plurality of spatially multiplexed fundamental image components and related masking image components derived from said fundamental image components being displayed on said image display device in association with said display regions and in such arrangement as to render said fundamental image components substantially indecipherable to the naked eye;
(c) said fundamental image components being representative of a fundamental image and being associated with said display regions having a common state of polarization that is different than the state of polarization of said display regions with which said masking image components are associated; and
(d) an image viewing device having polarization means cooperating with said image display device for allowing extraction and viewing only of said fundamental image components from said image display device.

2. (canceled)

3. The confidential viewing apparatus of claim 1, wherein at least some of said masking image components are the derived inverse of corresponding said fundamental image components displayed therewith, and the display of said fundamental and masking image components on said image display device generates a combined neutral image that appears substantially featureless to the naked eye.

4. The confidential viewing apparatus of claim 3, including overlay image components displayed in association with said masking image components such that an overlay image appears to the naked eye as being overlaid upon said substantially featureless image.

5. The confidential viewing apparatus of claim 1 or 3, wherein the display of said fundamental image components and said masking image components on said image display device are positionally alternated in time.

6. The confidential viewing apparatus of claim 1, wherein said fundamental image components are positionally altered in time to associate with separate sets of said display regions having differing polarization states.

7. The confidential viewing apparatus of claim 1, wherein at least said fundamental image components are time multiplexed with derived inverse image components thereof.

8. The confidential viewing apparatus of claim 1, wherein both said fundamental image components and said masking image components are time multiplexed with derived inverse image components thereof.

9. The confidential viewing apparatus of claim 8, wherein each of said masking image components is the derived inverse of a corresponding fundamental image component associated with the same said display region.

10. The confidential viewing apparatus of claim 1, wherein said polarization states of said display regions are fixed.

11. The confidential viewing apparatus of claim 1, wherein said polarization states of said display regions are variable.

12. The confidential viewing apparatus of claim 11, wherein each of said display regions include a variable polarizer capable of altering the state of polarization thereof.

13. The confidential viewing apparatus of claim 12, wherein said variable polarizer is comprised of an electrically-controlled liquid crystal device.

14. The confidential viewing apparatus of claim 1, wherein said different polarization states of said display regions are generally orthogonal to one another.

15. The confidential viewing apparatus of claim 1, wherein at least some of said display regions are left-hand circularly polarized and at least some of said display regions are right-hand circularly polarized.

16. The confidential viewing apparatus of claim 1, wherein said display regions with which said fundamental image components are associated are cross-polarized relative to said display regions with which said masking image components are associated.

17. The confidential viewing apparatus of claim 1, wherein said image display device is an electronic display device comprising a plurality of display pixels and having a periodic display refresh cycle, and wherein each of said display regions includes at least one of said pixels of said electronic display device.

18. The confidential viewing apparatus of claim 17, wherein said electronic display device includes a transparent overlay with designated separate areas of cross-polarized orientations that align with said pixels to form said plurality of differently polarized display regions.

19. The confidential viewing apparatus of claim 17, wherein said fundamental image components and said masking image components are regenerated upon each said display refresh cycle in association with a separate set of said pixels having a different polarization state than that of the next previous said display cycle of said electronic display device.

20. The confidential viewing apparatus of claim 19, wherein said image viewing device is comprised of active polarized eyewear which communicates with said electronic display device to change states of polarization in sync with said display refresh cycle of said electronic display device.

21. The confidential viewing apparatus of claim 17, wherein said display regions of said electronic display device include a variable polarizing means for altering the state of polarization thereof, and said image viewing device is comprised of active polarized eyewear that communicates with said electronic display device to change states of polarization in sync with changes in the polarization state of said display regions.

22. An apparatus for confidential viewing of a fundamental image utilizing spatial multiplexing image modification, comprising:
(a) an image display device comprising a plurality of adjacent display regions of different polarization states.
(b) means for generating an image on said image display device having a fundamental image component and a corresponding inverse image component spatially arranged in association with said display regions so as to form a combined image that appears substantially featureless to the naked eye;
(c) said image generating means and said image display device cooperatively communicating so that said fundamental image component is associated with at least one of said display regions having a polarization state different than that with which said inverse image component is associated; and
(d) image viewing means cooperatively polarized with said display regions of said image display device for allowing viewing only of said fundamental image component of said combined substantially featureless image.

23. The confidential viewing apparatus of claim 22, wherein said plurality of display regions are arranged in alternating columns of different polarization states.

24. The confidential viewing apparatus of claim 22, wherein said plurality of display regions are arranged in alternating rows of different polarization states.

25. The confidential viewing apparatus of claim 22, wherein said combined substantially featureless image is comprised of a plurality of said fundamental image components and corresponding inverse image components associated with alternating sets of said adjacent display regions having different polarization states.

26. The confidential viewing apparatus of claim 22, wherein said different polarization states of said display regions are generally orthogonal to one another.

27. The confidential viewing apparatus of claim 22, wherein at least some of said display regions are left-hand circularly polarized and at least some of said display regions are right-hand circularly polarized.

28. The confidential viewing apparatus of claim 22, wherein said plurality of display regions have fixed polarization states.

29. The confidential viewing apparatus of claim 22, wherein said plurality of display regions have variable polarization states.

30. The confidential viewing apparatus of claim 29, wherein each of said display regions comprise an electrically variable polarizer.

31. The confidential viewing apparatus of claim 30, wherein said variable polarizer comprises a liquid crystal device capable of altering polarization state.

32. The confidential viewing apparatus of claim 22, wherein said image display device constitutes an electronic display device having a plurality of display pixels, each of said display regions comprising at least one of said pixels of said electronic display device.

33. The confidential viewing apparatus of claim 32, wherein said fundamental image component is associated with at least one of said pixels having a common polarization state, and said corresponding inverse image component is associated with at least one of said pixels having a different polarization state.

34. The confidential viewing apparatus of claim 32, wherein said electronic display device is configured as a liquid crystal display device, and each of said display regions includes an electrically controllable polarizer that is comprised of a liquid crystal device capable of altering polarization state based on applied voltage thereto.

35. The confidential viewing apparatus of claim 32, including means for generating an overlay image visible to the naked eye and appearing over said substantially featureless image on said electronic display device, said overlay image having an overlay image component which is associated with at least one of said display regions having a polarization state common to that with which said inverse image component is associated.

36. The confidential viewing apparatus of claim 32, wherein said electronic display device includes a transparent polarizing overlay extending over said display pixels, said polarizing overlay being constructed and arranged to alter the polarization state of some of said display pixels to generate said plurality of display regions of different polarization states.

37. The confidential viewing apparatus of claim 22, wherein said image display device includes a transparent polarizing overlay constructed and arranged to generate said plurality of adjacent display regions of different polarization states.

38. The confidential viewing apparatus of claim 22, wherein said fundamental image component is regenerated anew over time in association with a different said display region.

39. The confidential viewing apparatus of claim 38, wherein said different display region has a polarization state different than that with which said fundamental image component was previously associated.

40. The confidential viewing apparatus of claim 38, wherein said corresponding fundamental and inverse image components switch associated display regions over time.

41. A method for confidential viewing of a fundamental image utilizing spatial multiplexing image modification, comprising the steps of:
(a) polarizing adjacently positioned display regions of an image display device with different states of polarization;
(b) displaying spatially multiplexed fundamental image components of a fundamental image with corresponding inverse image components thereof on said image display device in such arrangement as to neutralize and render said fundamental image components substantially invisible to the naked eye, whereby said fundamental image components are associated with said display regions having a state of polarization different than that with which said inverse image components are associated; and
(c) viewing said image display device through a polarized filtering means that communicates with said image display device and allows passage and viewing only of said fundamental image components of said fundamental image.

42. The method of confidential viewing set forth in claim 41, wherein said step of polarizing said adjacently positioned display regions of said image display device includes the use of at least one electrically variable polarizer capable of altering the state of polarization of at least one of said display regions relative to other said display regions.

43. The method of confidential viewing set forth in claim 42, wherein said step of polarizing said adjacently positioned display regions is carried out with at least one variable polarizer of liquid crystal construction capable of altering the state of polarization of at least one of said display regions relative to other said display regions based on applied voltage to said variable polarizer.

44. The method of confidential viewing set forth in claim 41, wherein said step of polarizing said adjacently positioned display regions of said image display device includes positioning a polarizing device having separate areas of differently fixed polarization states in alignment with said display regions of said image display device.

45. The method of confidential viewing set forth in claim 44, wherein said step of displaying spatially multiplexed image components includes varying over time the polarization state of said display regions with which said fundamental image components are associated.

46. The method of confidential viewing set forth in claim 41, wherein said step of displaying spatially multiplexed image components includes periodically alternating said display positions of said fundamental image components and said corresponding inverse image components to appear at differently polarized sets of said display regions of said image display device.

47. The method of confidential viewing set forth in claim 41, wherein said step of polarizing adjacently positioned display regions of said image display device includes arranging said display regions to alternate spatially between two states of polarization which are generally orthogonal to one another.

48. The method of confidential viewing set forth in claim 41, wherein said step of displaying spatially multiplexed image components includes displaying overlay image components representative of a separate overlay image on said image display device, whereby said overlay image components are associated with at least some of said display regions having a polarization state common to that with which said inverse image components are associated.

49. The method of confidential viewing set forth in claim 41, wherein said step of viewing said image display device utilizes passive polarized eyewear to allow passage and viewing only of said fundamental image components of said fundamental image.

50. The method of confidential viewing set forth in claim 41, wherein said step of viewing said image display device utilizes active polarized eyewear operating in sync with said image display device to allow passage and viewing only of said fundamental image components of said fundamental image.

51. The method of confidential viewing set forth in claim 41, wherein said step of polarizing adjacently positioned display regions with different states of polarization includes the use of right-hand and left-hand circular polarization.

52. The method of confidential viewing set forth in claim 41, wherein said step of displaying fundamental and corresponding inverse image components on said image display device generates a combined substantially featureless image to the naked eye.

53. The method of confidential viewing set forth in claim 41, including the step of periodically exchanging the display position of said fundamental and corresponding inverse image components, while coincidentally altering the polarization state of said display regions associated therewith so as to maintain a common polarization state over time for all said display regions associated with said fundamental image components being displayed.

54. A method for confidential viewing of a fundamental image utilizing spatial multiplexing image modification, comprising the steps of:
(a) positioning a transparent polarizing overlay over an image display device, said overlay comprising a plurality of adjacently positioned polarizers having different polarization states;
(b) producing a compound image on said display device that is comprised of a plurality of spatially multiplexed fundamental image components and masking image components aligned with said polarizers of said overlay, whereby said fundamental image components are representative of a fundamental image and said masking image components are derived from said fundamental image components, said fundamental image components being aligned with a group of said polarizers having a common state of polarization different from that with which said masking image components are aligned; and
(c) viewing said compound image through said overlay utilizing a lens filter polarized in such manner as to allow passage and viewing only of said fundamental image components of said fundamental image.

55. The method of confidential viewing described in claim 54, including the step of time multiplexing said fundamental and masking image components with derived inverse image components thereof.

56. The method of confidential viewing described in claim 55, wherein said step of viewing said compound image utilizes an active lens filter capable of altering its state of polarization to match that of said fundamental image components.
